(19) United States
(12) Patent Application Publication
(10) Pub. No.: US 2024/0334959 A1
(43) Pub. Date: Oct. 10, 2024

(54) PRODUCTION METHOD FOR OBTAINING HAZELNUT YOGHURT

(71) Applicant: BALSU GIDA SANAYI VE TICARET ANONIM SIRKETI, Sakarya (TR)

(72) Inventor: Emel OZENGEN, Sakarya (TR)

(73) Assignee: BALSU GIDA SANAYI VE TICARET ANONIM SIRKETI, Sakarya (TR)

(21) Appl. No.: 18/580,192

(22) PCT Filed: Aug. 4, 2022
(86) PCT No.: PCT/TR2022/050822

§ 371 Date: Jan. 18, 2024

(30) Foreign Application Priority Data
Sep. 15, 2021 (TR) 2021/014451

(51) Int. Cl. A23L 25/00; A23C 11/10

(52) U.S. Cl. CPC A23L 25/40; A23C 11/106

(57) ABSTRACT

Hazelnut yoghurt is provided, which does not include any animal product input in the production process steps for all consumers, particularly for vegan consumers, and which does not include any animal taste and odor and which has high nutrient values and long shelf lifetime. The production method of said hazelnut yoghurts is also provided.

### CROSS-REFERENCE TO THE RELATED APPLICATIONS

This application is the national phase entry of International Application No. PCT/TR2022/050822, filed on Apr. 8, 2022, which is based upon and claims priority to Turkish Patent Application No. 2021/014451, filed on Sep. 15, 2021, the entire contents of which are incorporated herein by reference.

### TECHNICAL FIELD

The present invention belongs to food sector technical field, and relates to hazelnut yoghurt which does not include any animal product input in the production process steps for all consumers, particularly for vegan consumers, and which does not include any animal taste and odor and which has high nutrient values and long shelf lifetime, and relates to the production method of said hazelnut yoghurts.

### BACKGROUND

It is probably high that yoghurt, which is a Turkish invention, is produced in countries which were under Turkish culture, and has been distributed to all around the world by time. Based on the manners of thousands of years, traditional yoghurt production has been realized by using the yoghurt of the prior day. As a result of the developments in science and technology, as standardization is provided in production, yoghurt has been produced in an industrial manner. Yoghurt includes chemical components which are similar to milk, but yoghurt shows differences because of the processes applied to milk during production and because of the changes which occur due to lactic acid fermentation realized by yoghurt bacteria.

Since pH level of yoghurt is low and since the ferments can use organic acids and can ferment lactose and have high photolytic and lipolytic activity, yoghurt becomes a selective medium for ferment development.

There are lactic acid bacteria inside yoghurt ferment. These bacteria ferment milk in a substantially rapid manner and yoghurt can be obtained as a result of chemical transformation. In the related technical field, milks are essentially transformed into yoghurt as a result of biochemical reactions of bacteria known as Streptococcus thermophilus and bulgaricus sub-type of Lactobacillus delbrueckii.

Chickpea ferment is obtained by breaking the chickpeas, obtained naturally, and by putting chickpeas into a jar with a specific amount, and by adding salt, flour, sugar and by adding hot water therein. The chickpeas are kept between 15-20 hours in order to be fermented in a medium with fixed temperature, and ferment is formed by time. Chickpea ferment is at the same time ferment formed by prebiotic and probiotic bacteria. These bacteria are useful for human health. These bacteria also occur during fermenting of home yoghurt. This ferment can also be named as “sweet ferment” in the art since it has a unique taste and a different odor. It has a structure such that pluralities of persons, who have digestion system problems or stomach problems, can comfortably consume. Not only bread but also yoghurt can be fermented from chickpea ferment. Chickpea ferment has various benefits for human health both in bread form and yoghurt form. It has plenty of vitamin B therein.

Herbal milk, also known as vegan milk in the art, is milk which does not include animal protein therein and which includes completely herbal nutrient sources. Particularly for vegan consumers, product variety is desired to be widened for the researchers in the related technical field.

During yoghurt production, for the health of consumers and for taking high nutrient values for the consumers, it is very important that milks can be obtained from various herbs such that the nutrient value is not lost and yoghurt can be obtained which does not include any additive substance.

Stabilizers, additive substances and various protective synthetic substances, added during yoghurt production, are generally added for providing stable structure to yoghurt and for providing long shelf lifetime to yoghurt. It is very important for the consumers that yoghurt does not include said synthetic additive substances in the related technical field.

As a result, in the related technical field, it is foreseen that a yoghurt product can meet the novelty criterion, where milk is obtained from herbs having high nutrient values and which can be consumed by all consumers, particularly vegan consumers and where pasteurization can be provided with minimum destruction of the nutrient values of these products and which does not include any synthetic additive substance and obtained by means of input of completely herbal components.

### SUMMARY

The present invention relates to production of hazelnut yoghurts which have high nutrient values, for meeting the abovementioned requirements and for bringing some additional advantages for the technical field of yoghurt production in food sector.

An object of the present invention is to provide a production method for hazelnut yoghurt which has high nutrient values by being pasteurized without destructing oil, protein and other nutrients in milk composition during production.

An object of the present invention is to provide a production method for hazelnut yoghurt where animal sourced products are not used as input during production.

An object of the present invention is to provide a production method for hazelnut yoghurt where synthetic chemical compounds are not used as input during production.

An object of the present invention is to provide a production method for hazelnut yoghurt which has long shelf lifetime.

In order to realize all of these objects, the present invention is a production method for hazelnut yoghurt which does not include any animal product input and which does not include any animal taste and odor and which has high nutrient values and long shelf lifetime and where high value of foods in hazelnut is pasteurized in a manner destructed at the minimum level, characterized by comprising the process steps of:
i) obtaining hazelnut milk from hazelnuts
   applying pre-cleaning processes for providing separation of galls and rotten from hazelnuts,
   adding the cleaned hazelnuts into water at a temperature between 5 and 15° C. and waiting,
   taking the wet hazelnut particles, removed from water, into mixer, grinder or stirrer devices and after adding water, fragmenting of hazelnuts by means of said devices, wherein said hazelnut/water proportion is configured such that it is at a value between ½ and ¼ grams/ml by volume,
   passing the obtained fragmented hazelnuts from milk cloth and obtaining hazelnut milk,
   applying thermal processes to the hazelnut milk separated from milk cloth,
ii) obtaining herbal ferments from chickpeas and obtaining yoghurt ferment
   boiling water with scale of at most 200 mL for chickpeas between 15 and 20 in number and cooling,
   adding chickpeas into water, adding salt and obtaining the mixture and wherein said mixture is incubated at a temperature between 40 and 45° C.,
   bringing the hazelnut milk, obtained in step i), to fermenting temperature, wherein said fermenting temperature is a temperature value between 40 and 45° C.,
   after the incubation process, the obtained chickpea ferment is added into the hazelnut milk brought to fermenting temperature and yoghurt ferment is obtained, wherein said chickpea ferment/hazelnut milk proportion is a value between 0.01/1 and 0.05/1 mL/mL by volume,
iii) obtaining hazelnut yoghurts as a result of fermenting of the hazelnut milks, obtained in step i), by chickpea ferments obtained in step ii)
   adding the yoghurt ferment, obtained in step ii), into hazelnut milks obtained in step i), wherein during the adding process, the yoghurt ferment and the hazelnut milks have temperature values between 40 and 45° C., wherein said yoghurt ferment/hazelnut milk proportion has a value between 0.01/1 and 0.03/1 mL/mL by volume,
   yoghurt fermenting process is realized, is waited at incubation temperature, the temperature of the waiting process has temperature values between 40 and 45° C.,
   the hazelnut yoghurt obtained after incubation process is left for cooling at temperature of +4° C.

In a possible embodiment of the present invention, hazelnut diameters are at a value between 10 and 12 mm.

In a possible embodiment of the present invention, hazelnuts are kept in cold water for at least 24 hours.

In a possible embodiment of the present invention, said milk cloth is at a maximum value of 50 microns.

In a possible embodiment of the present invention, said milk cloth is at a value of 30 microns.

In a possible embodiment of the present invention, said thermal process is realized at a fixed temperature between 70° C. and 95° C.

In a possible embodiment of the present invention, said thermal process is realized at a fixed temperature between 80° C. and 85° C.

In a possible embodiment of the present invention, the thermal process is realized for duration between 8 and 10 minutes.

In a possible embodiment of the present invention, said salt amount is at a value between 1 and 1.5 grams.

In a possible embodiment of the present invention, in process step ii), said incubation processes are realized for at least 12 hours.

In a possible embodiment of the present invention, in process step iii), said incubation processes are realized for at least 12 hours.

### DETAILED DESCRIPTION OF THE EMBODIMENTS

In this detailed description, the subject matter belongs to food sector technical field, and relates to hazelnut yoghurt which does not include any animal product input in the production process steps for all consumers, particularly for vegan consumers, and which does not include any animal taste and odor and which has high nutrient values and long shelf lifetime, and relates to the production method of said hazelnut yoghurts, and is explained with references to examples without forming any restrictive effect only in order to make the subject more understandable.

For providing all characteristics, production of hazelnut yoghurt essentially comprises the process steps of:
i) obtaining hazelnut milk from hazelnuts,
ii) obtaining chickpea ferments and yoghurt ferment as ferment,
iii) obtaining hazelnut yoghurts as a result of the process of fermenting of hazelnut milks, obtained in step i), by means of the chickpea ferments obtained in step ii).

In said process step i), raw hazelnuts are picked and cleaned. Raw hazelnuts are classified according to their calibers, and hazelnuts which have diameters between 10 and 12 mm are preferred for obtaining the subject matter hazelnut yoghurt. As the raw hazelnuts are picked, the galls and rotten hazelnuts are sieved and pre-cleaning processes are realized. The hazelnuts are taken to vessels with specific dimensions and they are filled with water until water covers the top of hazelnuts. The water added here is cold water and at least 24 hours must pass for waiting the hazelnuts. The hazelnuts are kept in water at a temperature between 5 and 15° C. This temperature value is preferred to be 10° C. Thus, since the hazelnuts have not been subjected to any thermal process while the hazelnuts are in natural form, they can be corned without deteriorating the oil structure or without being oxidized.

As a result of keeping hazelnuts in cold, mixer, grinder or stirrer devices are used for taking wet hazelnut particles from water and for fragmenting wet hazelnuts. Water is added to obtained hazelnuts which are in powder form. Here, the mentioned hazelnut/water proportion is configured to be at a value between ½ and ¼ grams/ml by volume. The next process is passing the fragmented hazelnuts through milk cloth. The material which can be used as milk cloth is essentially a cotton woven fabric. The pore dimensions of said cotton woven fabric are at most 50 microns, and preferably milk clothes which have 30 microns or lower micron values are used. While pulp of the hazelnut powders remains in milk clothes, the liquid which can pass through the pores is evaluated as hazelnut milk. Thermal process is applied to the obtained hazelnut milk at a fixed temperature between 70 and 95° C. and preferably between 80 and 85° C. Said thermal processes are realized at duration between 8 and 10 minutes to fixed temperatures. By means of this pasteurization process of the invention applied to hazelnut milk, no preserving or flavoring substance is used, and hazelnut milk is obtained which can be preserved for long duration without deteriorating purity, taste, odor and color.

In process step ii), chickpea ferment is obtained. First of all, water is boiled at an amount of at most 200 mL for chickpea particles between 15 and 20 in number and afterwards cooling is realized. Said chickpeas are subjected to grinding processes so as to be turned into powdered form.

Salt between 1 and 1.5 grams and chickpeas between 15-20 in number are added to said boiled-cooled water, and a mixture is obtained. The obtained mixture is incubated for duration of at least 12 hours at a temperature value between 40 and 45°° C. As a result of this process, chickpea ferment is obtained.

The hazelnut milk obtained as a result of application of process steps included to process step i) is brought to fermenting temperature. Said fermenting temperature is a temperature value between 40° C. and 45° C., and preferably the temperature value is between 40° C. and 43° C. The obtained chickpea ferment is added to the hazelnut milk obtained in step i) and yoghurt ferment can be obtained as a result of these processes. Here, said hazelnut milk is at fermenting temperature. For the yoghurt ferment process, the chickpea ferment/hazelnut milk proportion is at a value between 0.01/1 and 0.05/1 mL/mL by volume, this value is preferably 0.03/1 by volume.

In step iii), the yoghurt ferment obtained in step ii) is taken at specific amounts by volume and is added to hazelnut milk obtained in step i) and brought to fermenting temperature. Here, the yoghurt ferment/hazelnut milk ratio can be at a value between 0.01/1 and 0.05/1 mL/mL by volume. The obtained mixture is incubated for at least 12 hours at a temperature between 40 and 45° C., preferably between 40 and 43° C. after some mixing actions. The incubated mixture is left for cooling at temperature of +4° C. and hazelnut yoghurt is obtained.

The subject matter hazelnut yoghurt is a product which has high nutrient values and includes protein, vitamins and various rich oils. Obtaining yoghurt by pasteurizing such that the nutrient of hazelnuts at high value is destructed at the minimum level can be provided by means of the subject matter production method.

The hazelnut yoghurt obtained by means of the subject matter method does not include any chemical additive substance and completely herbal components are obtained. In a different manner from the starter cultures known in the art, the subject matter yoghurt, obtained by using the ferment obtained from chickpeas, has shelf lifetime of at least 1.5 months. Thanks to this characteristic, it is apparent that the present invention provides novelty to the related technical field.

The hazelnut yoghurt obtained by means of the subject matter production methods is consistent as the yoghurts known in the art, and there is no animal product input particularly for vegan consumers, and does not include animal odor and taste.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### EXAMPLE

An example product is obtained by means of the subject matter hazelnut yoghurt production method.
raw hazelnut with dimensions 10-11 mm has been taken,
galls and rotten hazelnuts have been cleaned,
the cleaned hazelnuts have been taken to a big vessel,
water has been added to the vessel such that water fills over the hazelnuts,
hazelnuts have been kept in cold water for 24 hours, wherein the temperature of water is 10° C.,
wet hazelnut particles have been taken, 200 grams of hazelnut has been taken to the mixer and 400 mL water has been added thereon,
this obtained mixture has been whipped by means of mixer for 5 minutes,.
the obtained mixture has been passed through the milk cloth,.
the obtained milk has been subjected to thermal processes, wherein the thermal process takes place at temperature between 80 and 85° C. and for 15-20 minutes, hazelnut milk has been obtained,
200 mL water has been boiled and cooled,.
15-20 chickpeas and 1.5 grams of salt have been added to the water and the mixture has been obtained,.
the mixture has been incubated for 12 hours at 43° C. such that the inlet is open, and chickpea ferment has been prepared,
the milk, prepared beforehand, has been brought to fermenting temperature,
the prepared 15 mL chickpea ferment has been added to 500 mL hazelnut milk at fermenting temperature,
the mixture has been mixed and has been incubated for 12 hours at 43° C. and yoghurt ferment has been prepared,
15 mL of yoghurt ferment has been added into 500 mL hazelnut milk which has been prepared beforehand and which is at ferment temperature and has been incubated for 12 hours,
afterwards, this has been left for cooling at 4° C. and hazelnut yoghurt has been obtained.

What is claimed is:

1. A production method for hazelnut yoghurt, wherein the hazelnut yoghurt which does not comprise any animal product input, does not comprise any animal taste and odor, and which has high nutrient values and long shelf lifetime and where high value of foods in hazelnut is pasteurized in a manner destructed at a minimum level, wherein the production method comprises the process steps of:
i) obtaining hazelnut milk from hazelnuts
applying pre-cleaning processes for providing separation of galls and rotten from the hazelnuts to obtain cleaned hazelnuts,
adding the cleaned hazelnuts into water at a temperature between 5 and 15° C. and waiting to obtain wet hazelnut particles,
taking the wet hazelnut particles, removed from water, into mixer, grinder or stirrer devices and after adding water, fragmenting of the hazelnuts by means of the mixer, grinder or stirrer devices, wherein a hazelnut/water proportion is configured to be at a value between ½ and ¼ grams/ml by volume to obtain fragmented hazelnuts,
passing the obtained-fragmented hazelnuts from milk cloth and obtaining hazelnut milk,
applying thermal processes to the hazelnut milk separated from the milk cloth,
ii) obtaining herbal ferments from chickpeas and obtaining yoghurt ferment
boiling water with scale of at most 200 mL for the chickpeas between 15 and 20 in number and cooling,
adding the chickpeas into water, adding salt and obtaining mixture, wherein the mixture is incubated at a temperature between 40 and 45° C. to obtain chickpea ferment,
bringing the hazelnut milk, obtained in step i), to fermenting temperature, wherein the fermenting temperature is a temperature value between 40 and 45° C.,
after the incubation process, the chickpea ferment is added into the hazelnut milk brought to the fermenting temperature and yoghurt ferment is obtained, wherein a chickpea ferment/hazelnut milk proportion is a value between 0.01/1 and 0.05/1 mL/mL by volume,
iii) obtaining the hazelnut yoghurts as a result of fermenting of the hazelnut milks, obtained in step i), by the chickpea ferments obtained in step ii)
adding the yoghurt ferment, obtained in step ii), into the hazelnut milks obtained in step i), wherein during the adding process, the yoghurt ferment and the hazelnut milks have temperature values between 40 and 45° C., wherein a said yoghurt ferment/hazelnut milk proportion has a value between 0.01/1 and 0.03/1 mL/mL by volume,
yoghurt fermenting process is realized, is waited at an incubation temperature, the temperature of the waiting process has temperature values between 40 and 45°° C.,
the hazelnut yoghurt obtained after incubation process is left for cooling at temperature of +4° C.

2. The production method according to claim 1, wherein hazelnut diameters are at a value between 10 and 12 mm.

3. The production method according to claim 1, wherein the hazelnuts are kept in cold water for at least 24 hours.

4. The production method according to claim 1, wherein the said milk cloth is at a maximum value of 50 microns.

5. The production method according to claim 4, wherein themilk cloth is at a value of 30 microns.

6. The production method according to claim 1, wherein the thermal process is realized at a fixed temperature between 70° C. and 95° C.

7. The production method according to claim 6, wherein the thermal process is realized at a fixed temperature between 80° C. and 85° C.

8. The production method according to claim 1, wherein the thermal process is realized for duration between 8 and 10 minutes.

9. The production method according to claim 1, wherein the said salt amount is at a value between 1 and 1.5 grams.

10. The production method according to claim 1, wherein in process step ii), the incubation processes are realized for at least 12 hours.

11. The production method according to claim 1, wherein in process step iii), the incubation processes are realized for at least 12 hours.

12. Hazelnut yoghurt obtained by applying the production method according to in claim 1.

13. The hazelnut yoghurt according to claim 12, wherein the hazelnut yoghurt comprises herbal-based components.

14. The production method according to claim 2, wherein the hazelnuts are kept in cold water for at least 24 hours.

15. The production method according to claim 2, wherein the milk cloth is at a maximum value of 50 microns.

16. The production method according to claim 3, wherein the milk cloth is at a maximum value of 50 microns.

17. The production method according to claim 2, wherein the thermal process is realized at a fixed temperature between 70° C. and 95° C.

18. The production method according to claim 3, wherein the thermal process is realized at a fixed temperature between 70°° C. and 95° C.

19. The production method according to claim 4, wherein the thermal process is realized at a fixed temperature between 70°° C. and 95°° C.

20. The production method according to claim 5, wherein the thermal process is realized at a fixed temperature between 70° C. and 95° C.
